(19) United States
(12) Patent Application Publication
(10) Pub. No.: US 2010/0196550 A1
(43) Pub. Date: Aug. 5, 2010

(54) Chocolate Confectionery Product With Superior Stability

(76) Inventors: Melissa Navarro Mussumeci, Campo Comprido-Curitiba-Parana (BR); Claudine de Sá Botelho Pinto, Santo Inacio-Curitiba-Parana (BR)

Correspondence Address: FITCH EVEN TABIN & FLANNERY, 120 SOUTH LASALLE STREET, SUITE 1600, CHICAGO, IL, 60603-3406, US

(21) Appl. No.: 12/696,709

(22) Filed: Jan. 29, 2010

Related U.S. Application Data
(60) Provisional application No. 61/148,849, filed on Jan. 30, 2009.

(51) Int. Cl. B65D 65/40; A23G 3/00; A23G 3/54; B65D 81/24

(52) U.S. Cl. 426/90; 426/126; 426/396

(57) ABSTRACT

Packaged chocolate confectionery products and method described herein provide substantially increased stability and shelf life. The packaging and method is particularly suited for extending the stability and shelf life of chocolate confectionery items comprising a first chocolate component and a second component comprising a food ingredient, such as nuts, wafers, biscuits, liqueurs, fruit fillings, fat-containing fillings, and combinations thereof. The package comprises a rigid thermoformed or injection formed container having at least one recessed area surrounded by a peripheral sealing rim. A membrane, which is substantially impervious to oxygen and moisture, is sealed to the peripheral sealing rim. The container is formed of a thermoplastic laminate including at least one oxygen barrier layer, which is positioned between at least one inner and at least one outer polymer layer. The barrier layer is substantially impervious to oxygen and is effective to enhance the moisture barrier properties of the container.

### CROSS-REFERENCE TO RELATED APPLICATION

This application claims the benefit of U.S. Provisional Application No. 61/148,849, filed Jan. 30, 2009, which is hereby incorporated herein by reference in its entirety.

### FIELD

The invention relates generally to chocolate confections and to a method for increasing stability of chocolate confections.

### BACKGROUND

Chocolate confectionery items have unique texture and flavor release properties in the mouth. Many of these desirable properties are generally attributable to cocoa butter, which has a narrow melting point range slightly below normal body temperature and a sharp melting curve. Accordingly, the desirable flavor release and organoleptic sensations of chocolate occur rapidly as the chocolate melts in the mouth. Preserving and protecting the unique, desirable organoleptic properties of chocolate confections from the time the confections are made until the time they are consumed has been the subject of much effort.

While chocolate is generally shelf stable at room temperature, the shelf life of some chocolate confections can be improved with storage at a temperature of about 55 to about 70° F. However, when chocolate is refrigerated, moisture may condense on the surface of the chocolate and may dissolve sugar in the chocolate. When the chocolate is returned to room temperature, the moisture evaporates, leaving an unappealing crust of sugar crystals on the surface called “sugar bloom.” “Fat bloom,” where fat or cocoa butter separates from the chocolate mixture and rises to the surface to form irregular spots or blotches, can also occur when chocolates are exposed to rapid temperature changes.

Some attempts have been made to increase the shelf life of chocolate products by careful selection of ingredients. U.S. Pat. No. 5,585,135 states that chocolates containing peanuts with high oleic acid content have a longer shelf life than those containing conventional peanuts.

One commercially successful confectionery product comprises a rigid, thermoformed tray made of polyethylene terephthalate having a plurality of cavities formed therein, with each cavity containing an individual chocolate confectionery item. A flexible cover is peelably sealed to the tray. The tray provides mechanical protection for the confectionery items at relatively light weight and cost, protecting them from deformation and damage due to external forces and preventing the confectionery items from contacting and damaging one another during shipping and handling. However, while the shelf life of certain chocolate confectionery products employing this type of packaging is satisfactory, it has been found that there is significant room for improvement with respect to stability of other products.

There has long been a need for methods to provide chocolate confections having improved stability and increased shelf life while also preventing unacceptable levels of bloom from developing prior to consumption.

### SUMMARY

The chocolate confectionery products and method described herein provide substantially increased stability and shelf life. The packaging described herein substantially reduces adverse organoleptic reactions or interactions such that the stability and shelf life of the chocolate confections is increased. The packaging may be suited for extending the stability and shelf life of a variety of chocolate confectionery products, including enrobed confections, truffles, solid molded chocolates, filled molded chocolates, hollow molded chocolates, enrobed biscuits, enrobed wafers, and the like. The packaging is particularly suited for extending the stability and shelf life of chocolate confectionery items comprising a chocolate component and a second component comprising a food ingredient such as nuts, wafers, fat-containing fillings, biscuits, dried fruits, and the like.

The package preferably comprises a rigid thermoformed or injection-molded container having at least one recessed area surrounded by a peripheral sealing rim and a membrane sealed to the peripheral sealing rim. The container is preferably formed of a thermoplastic laminate, i.e., a material comprising multiple layers, preferably including at least one oxygen barrier layer. The barrier layer is positioned between at least one inner polymer layer and at least one outer polymer layer. The barrier layer is substantially impervious to oxygen and is effective to enhance the moisture barrier properties of the container. As used herein, “oxygen barrier” and “substantially impervious to oxygen” mean that the material has an oxygen transmission rate of less than 5 cc/m²/24 hr, more preferably less than about 3 cc/m²/24 hr, most preferably less than about 1 cc/m²/24 hr.

The sealing membrane is substantially impervious to oxygen and moisture. Preferably, the membrane comprises a high barrier material such as, but not limited to, metalized film, aluminum foil, or a high barrier transparent film. As used herein, “high barrier” and “substantially impervious to moisture and oxygen” or similar phrases mean that the material has an oxygen transmission rate of less than 5 cc/m² day, preferably less than about 3 cc/m²/24 hr, more preferably less than about 1 cc/m² day and a water vapor transmission rate that is less than 5 g/m²/24 hr, preferably less than 3 g/m²/24 hr, and more preferably less than about 1 cc/m²/24 hr.

The method provided herein for improving the shelf life of chocolate confectionery products comprises: (1) providing a rigid thermoformed or injection-molded container comprising at least one recessed area surrounded by a peripheral sealing rim, the container being formed of a thermoplastic laminate comprising an oxygen barrier layer positioned between at least one inner polymer layer and at least one outer polymer layer, the barrier layer being substantially impervious to oxygen and effective to enhance the moisture barrier properties of the container; (2) depositing one or more chocolate confectionery items in the at least one recessed area of the container, the one or more chocolate confectionery items comprising a chocolate component and a second component comprising a food ingredient such as, but not limited to, nuts, wafers, biscuits, liqueurs, fruit fillings, and fat-containing fillings; and (3) sealing a membrane to the peripheral sealing rim of the container, the membrane comprising a metalized film that is substantially impervious to oxygen and moisture, wherein the container and membrane have an oxygen transmission rate of less than 5 cc/m²/24 hr, preferably less than about 3 cc/m²/24 hr, more preferably less than about 1 cc/m²/24 hr and a water vapor transmission rate that is less than 5 g/m²/24 hr, preferably less than 3 g/m²/24 hr, and more preferably less than about 1 cc/m²/24 hr.

### BRIEF DESCRIPTION OF THE DRAWINGS

FIG. 1 is a perspective view of a sealed container.

FIG. 2 is a cross-sectional view taken along line 3-3 of FIG. 1.

FIG. 3 is an enlarged partial section showing the various layers of a rigid container structure.

FIG. 4 is a perspective view of a heart-shaped tray with the sealing membrane partially removed.

FIG. 5 is a perspective view of a cup-shaped container according to the invention with the sealing membrane partially removed.

FIG. 6 is a side view of the cup-shaped container according to FIG. 5 with a lid fitted over the sealing membrane.

### DETAILED DESCRIPTION

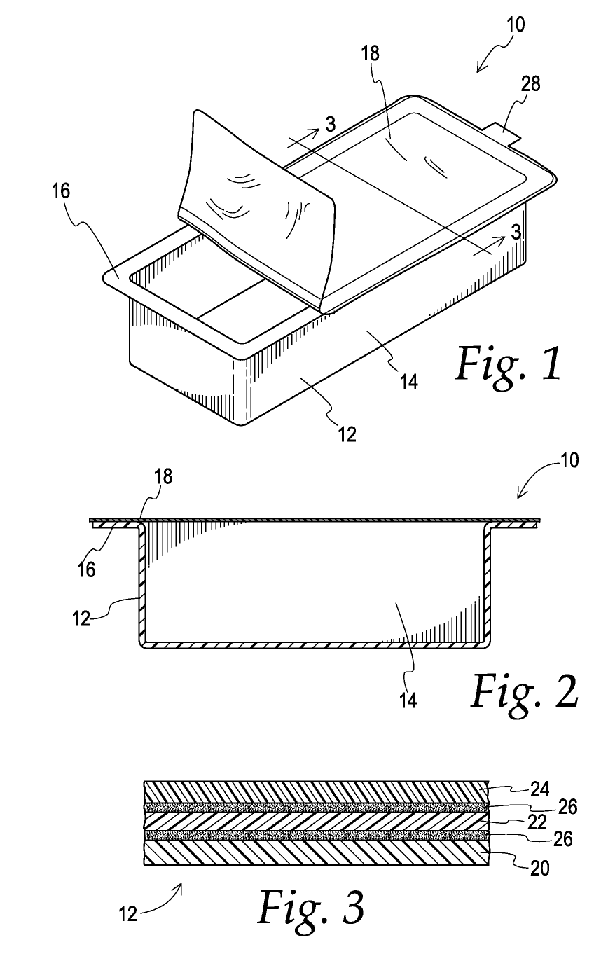

Packages that may be used for packaging chocolate confections, particularly enrobed chocolate confections, are illustrated in FIGS. 1-6. The term “chocolate confections” includes solid chocolate, nut-containing chocolates, enrobed chocolates, truffles, solid molded chocolates, filled molded chocolates, hollow molded chocolates, enrobed biscuits, enrobed wafers, and the like. While the packages provided herein may be used for packaging solid chocolates, the packages described herein provide the greatest increase in stability and shelf life for chocolate confections, such as chocolate enrobed confections, comprising nuts, wafers, biscuits, liqueurs, fruit fillings (e.g., raspberry, strawberry, blackberry, apricot, guava, passion fruit, peach, blueberry, raisin, cherry, and the like), and fat-containing fillings (e.g., crème, caramel, peanut butter, chocolate, cream cheese, cream, and the like). Examples of nuts that may be incorporated in the products include but are not limited to peanuts, hazelnuts, macadamia nuts, pecans, walnuts, cashews, almonds, Brazil nuts, chestnuts, pistachios, and like.

Some pure chocolate confections may have a shelf life of about one year. However, it has been found that certain chocolate confections containing nuts, wafers, biscuits, or other food ingredients in combination with chocolate may have a significantly shorter shelf life at room temperature, e.g., about eight months. The sealed package 10 described herein has been found to provide significant increases in stability and shelf life for certain chocolate confections. It is believed that the oils present in the nuts may oxidize over time under certain circumstances, and that this may have an undesirable effect on the flavor of the chocolate product. It is believed that the superior stability associated with the packaging described herein is due partially, but not entirely, to decreased rates of transmission of oxygen through the packaging material.

The package 10 of FIGS. 1-2 comprises a container 12 having at least one recessed area 14 surrounded by a peripheral sealing rim 16 and a membrane 18 sealed to the peripheral sealing rim 16. The container 12 is formed from a laminated material including at least one barrier layer. As shown in FIG. 3, the illustrated container comprises at least an inner layer 20, a barrier layer 22, and at least one an outer layer 24 where the barrier layer 22 is between the inner and outer layers. Adhesive layers 26 may be employed between the inner and outer layers 20 and 24 and the barrier layer 22. Preferred adhesives include polyethylene and polyamide, but other adhesives may be used if desired.

The outer and inner layers 20 and 24 generally comprise about 70 to about 97 percent, preferably about 80 to about 95 percent, of the thickness of the laminated material, while the barrier layer 22 generally comprises about 1 to about 20 percent, preferably about 4 to 10 percent, of the thickness of the laminated material and the adhesive generally comprises about 2 to about 10 percent of the thickness of the laminated material.

Generally, the laminated sheet used to form the containers should be thicker than the intended thickness of the container to be manufactured because prestretching and the thermoforming process can cause significant reduction in the thickness of the laminated sheet. It should also be recognized that the thicknesses of the various layers in the laminated sheet may not decrease uniformly (i.e., one layer may decrease more than another). It should further be recognized that the barrier properties (e.g., WVTR and OTR) of the laminated sheet can decrease as the thickness of the sheet decreases. Of course, the thickness of the laminated sheet will depend on the desired size of the final container and the method used to form the final container (e.g., thermoforming, injection molding, and the like). Generally, the thickness of the laminated sheet is about 300 to about 2250 microns in one aspect, about 450 to about 1875 microns in another aspect, and about 600 to about 1500 microns in yet another aspect.

As will also be recognized by one of ordinary skill in the art, the thickness of the container will depend on the specific product application, as well as the size of the final container, although generally the wall thickness of the rigid container should be about 150 to about 630 microns, preferably about 250 to about 500 microns. For a cup-shaped container or a tray having individual cavities for confections, generally the sidewalls of the container or cavities are thinner than the base of the cavity or cup. The sidewalls are generally about 75 to about 300 microns in one aspect, about 112.5 to about 250 microns in another aspect, and about 150 to about 200 microns in another aspect. In one aspect, the base of the cavity or cup is about 210 to about 630 microns, and about 315 to about 525 microns in another aspect.

The material used to form the containers of the invention can be manufactured using conventional coextrusion and film blowing technology or via other conventional methods as desired.

The inner and outer layers 20 and 24, respectively, are made of a polymer that provides structural integrity to the package, and to some extent a barrier to moisture and oxygen. Suitable polymers include, but are not limited to, polypropylene, polyethylene, polyamide, nylon, and the like. The inner and outer layers may comprise the same or different polymers or combinations thereof. The polymers used in the laminate may be purchased commercially or may be manufactured using conventional methods.

The oxygen barrier layer 22 should be between the at least one inner layer 20 and outer layer 24. The packaging described can delay the onset of oxidation, and thus increase stability to maintain the flavor and crunchiness, if applicable, of the product over a longer shelf life.

In contrast, exposure of chocolate confections to moisture can result in surface cracking. It is generally believed that the outer layer of a chocolate confection serves as a moisture barrier, particularly with respect to enrobed confections, but that imperfections in the outer surface may allow for moisture migration into the confection over time. Absorption of moisture can result in increased stress on the surface of the chocolate, thus resulting in the formation of cracks. Such imperfections are typically unacceptable to consumers. When sealed rigid thermoformed containers including an EVOH barrier layer were compared to similar containers without an EVOH layer, it was surprisingly found that chocolate confections in the non-EVOH packages formed cracks on the surface during storage after shorter periods of time than did those in the EVOH-containing containers. A barrier layer that serves as an oxygen barrier but not as a moisture barrier would not be effective to delay such cracking. Therefore, it was surprisingly found that certain oxygen barrier layers, such as EVOH, were also effective to enhance the moisture barrier properties of the packaging. It is believed that the EVOH barrier layer in the packages described herein may initially serve as a water vapor barrier by absorbing water vapor and preventing passage of the water vapor into the container and that, upon reaching maximum absorption, EVOH may then have a reduced effectiveness as a moisture barrier such that moisture will pass through the barrier layer to the interior of the container.

Therefore, the barrier layer selected for use in the rigid thermoformed container described herein should be effective for preventing diffusion of gases, such as, for example, oxygen, through the barrier film as well as for enhancing the moisture barrier properties of the container. Suitable barrier film layers include, but are not limited to, ethylene vinyl alcohol (EVOH), and the like.

If desired, the polymers used to make the thermoplastic laminate containers described herein may also contain standard additives, such as pigments, dyes, and the like.

The membrane 18 used to seal the container should also provide a barrier to oxygen and moisture. The membrane 18 is substantially impervious to oxygen and moisture. Preferably, the membrane comprises a high barrier material such as, but not limited to, metalized film, aluminum foil, or a high barrier transparent film. As used herein, “high barrier” and “substantially impervious to moisture and oxygen” or similar phrases mean that the material has an oxygen transmission rate of less than 5 cc/m²/24 hr, preferably less than about 3 cc/m²/24 hr, more preferably less than about 1 cc/m²/24 hr and a water vapor transmission rate that is less than 5 g/m²/24 hr, preferably less than 3 g/m²/24 hr, and more preferably less than about 1 cc/m²/24 hr.

Preferably, the membrane 18 is hermetically sealed, such as by heat sealing, to the sealing rim 16 of the container 12. The membrane is generally flexible and substantially impervious to oxygen and moisture. The membrane should also be capable of forming a seal, such as by heat sealing, with the surface of the sealing rim 16 of the container 12. The membrane should exhibit sufficient heat resistance so as to maintain the integrity of the sealing membrane during the sealing process, e.g., to maintain its shape and moisture barrier properties at heat sealing temperatures. The membrane should also be capable of being heat sealed to the container at a temperature and for a time period such that the chocolate confections in the package are not adversely affected (e.g., melted) by exposure to increased temperatures during the heat sealing process. In this respect, the shape and configuration of the container and the chocolate confections therein should be taken into consideration when selecting a membrane and sealing temperature.

Preferably, the membrane is easily removable (e.g., peeled) from the container to allow access to the chocolate confections but provides a sufficiently tight seal so that the membrane does not dislodge during shipping and handling. Preferably, the membrane includes an “easy open” feature, such as a pull tab 28 as illustrated in FIG. 1.

The container may be formed into the desired structural shape and from the laminated polymeric materials described herein. For example, the container can be formed into a cup, container, tray, or the like. The shape of the container can be formed using conventional techniques, such as injection-molding and thermoforming, including vacuum forming, plug assist thermoforming, and plug assist vacuum forming, and the like. The container may also be formed to have a single cavity or multiple cavities for receiving the chocolate confections.

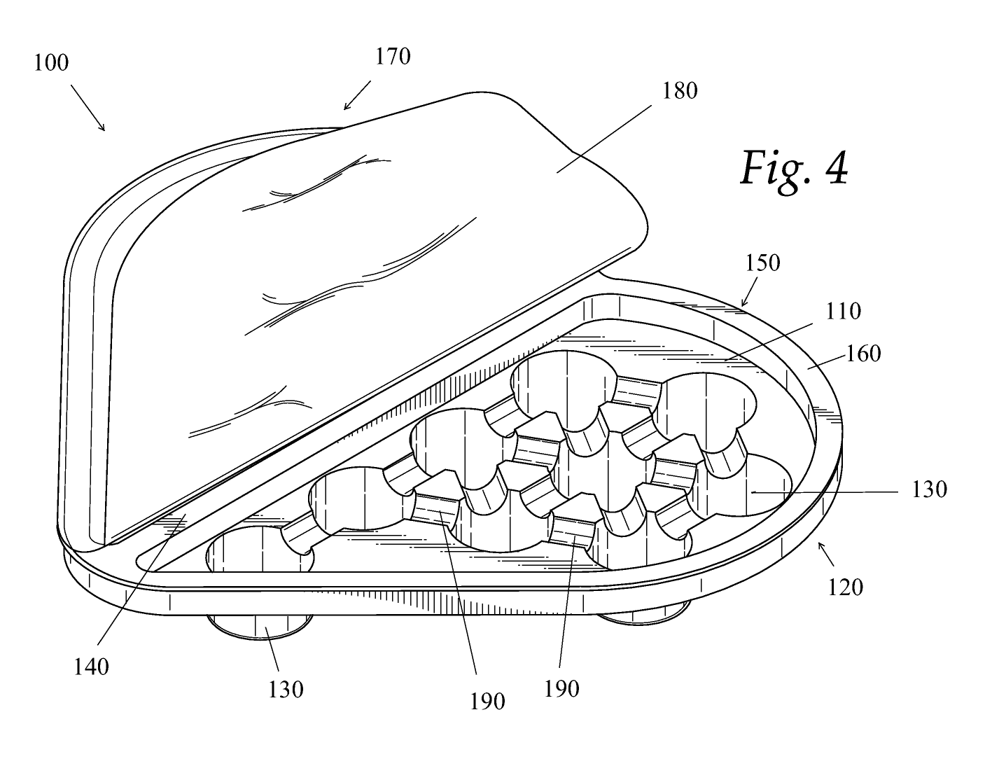

For example, the container may be formed as a heart-shaped container with a plurality of recesses or cavities, where each recess is configured to receive a chocolate confection. For example, as shown in FIG. 4, the illustrated package 100 comprises a heart-shaped container 120 having a plurality of cavities 130 in upper surface 110. Cavities 130 are configured to contain chocolate confectionery items. The container 120 can be formed from a laminated material including at least one barrier layer, as previously described and shown in FIG. 3. The container includes peripheral sealing rim 160 and sealing division 140. Sealing division 140 divides the heart-shaped container 120 into halves 150 and 170. Membrane 180 is sealed to sealing rim 160 and sealing division 140. Sealing division 140 permits the consumer to remove membrane 180 from each half of the heart-shaped container without breaking the seal of the membrane on the other half of the container, and thus can consume the chocolate confections on the unsealed half of the package while advantageously maintaining the freshness of the chocolate confectionery items in the sealed half. Recesses 190 connect adjacent cavities 130 on surface 110. Recesses 190 are configured to enable the consumer to more easily grasp the chocolate confections within the cavities.

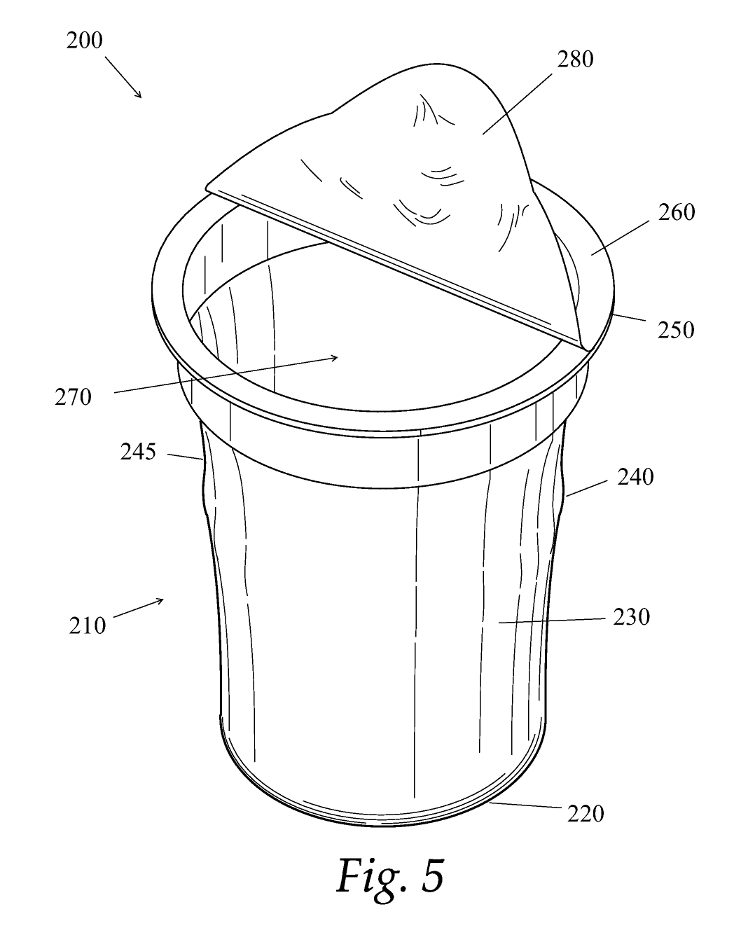

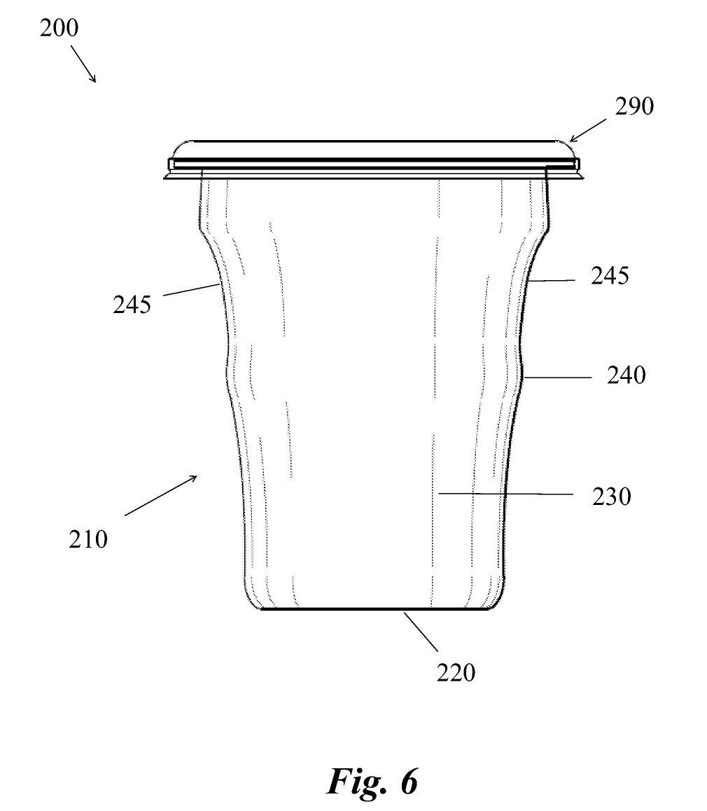

Also, as shown in FIGS. 5 and 6, the illustrated package 200 can be formed, for example, as a cup-shaped container 210 configured to hold a plurality of confections. Cup-shaped container 210 has circular base wall 220 and cylindrical sidewall 230 extending upwardly therefrom to form cavity 270, which is configured to hold a plurality of chocolate confectionery items. The container 210 can be formed from a laminated material including at least one barrier layer, as previously described and shown in FIG. 3. The sidewall 230 extends upwardly to a slightly convex waist portion 240 and a concave portion 245. A lip portion 250 is formed around the periphery of the sidewall 230 of the container 210 opposite the circular base wall 220. The lip portion 250 provides peripheral sealing rim 260. A flexible membrane 280 extends over cavity 270 and seals the opening. FIG. 5 shows the flexible membrane 280 partially peeled removed from peripheral sealing rim 260. As shown in FIG. 6, the cup-shaped container 210 may also have a lid 290, such as, for example, a plastic lid fitted over membrane 280 and around peripheral sealing rim 260.

The cost of materials that have both suitable barrier properties and the mechanical properties necessary to enable them to be incorporated into a thermoformed container can be problematic when attempting to manufacture a commercially viable package for confectionery products at a suitable price point. Thus, where cost of barrier material is a critical issue, it may be highly desirable that the thickness of the barrier material be controlled within predetermined ranges, such that the average thickness in relatively thin areas such as cavity sidewalls is sufficient to maintain oxygen penetration within acceptable limits while the cost is controlled by maintaining a relatively low thickness overall in the sheet material used for thermoforming.

It has been found that surprisingly good improvement in product stability can be achieved at acceptable cost with barrier materials such as EVOH where the variation between the average thickness of said barrier layer may be described by the following inequality:

$${x}_{1} \leq \frac{a}{b} \leq {x}_{2}$$

where
a=said average thickness of said barrier layer in cavity sidewall;
b=said average thickness of said barrier layer in sheet;
x₁=0.25; and
x₂=0.75.

The method provided herein for improving the shelf-life of chocolate confectionery products comprises: (1) providing a rigid thermoformed container comprising at least one recessed area surrounded by a peripheral sealing rim, the container being formed of a thermoplastic laminate comprising an oxygen barrier layer positioned between at least one inner polymer layer and at least one outer polymer layer, the barrier layer being substantially impervious to oxygen and effective to enhance the moisture barrier properties of the container; (2) depositing one or more chocolate confectionery items in the at least one recessed area of the container, the one or more chocolate confectionery items comprising a first chocolate component and a second component comprising a food ingredient selected from the group consisting of nuts, wafers, biscuits, liqueurs, fruit fillings, and fat-containing fillings; and (3) sealing a membrane to the peripheral sealing rim of the container, the membrane comprising a metalized film that is substantially impervious to oxygen and moisture, wherein the container and membrane have an oxygen transmission rate of less than 5 cc/m²/24 hr, preferably less than about 3 cc/m²/24 hr, more preferably less than about 1 cc/m²/24 hr and a water vapor transmission rate that is less than 5 g/m²/24 hr, preferably less than 3 g/m²/24 hr, and more preferably less than about 1 cc/m²/24 hr. Optionally, the chocolate confections are sealed in the container after flushing the container with nitrogen and evacuating to reduce oxygen which can cause deterioration.

It is an advantage of the package and method described herein that chocolate confections can be packaged to improve the stability and shelf life. It was surprisingly found that inclusion of a barrier layer substantially increased both the stability and shelf life of chocolate confections, particularly with respect to enrobed confections. Chocolate confections packaged in the packages described herein are shelf stable for at least about eight months, preferably at least about 10 months, and more preferably at least about 12 months. As defined herein, shelf stable means that the chocolate confections have organoleptic and textural characteristics substantially similar to that of freshly made chocolate confections.

### EXAMPLES

### Example 1

In this experiment, heart-shaped tray samples were produced on a pilot machine according to three different laminate specifications as described below. Four different membranes were provided. Chocolates were placed in the trays. Each of the four membranes was separately applied to each of the three tray specifications to determine which combinations of trays and membranes formed a tight seal.

The trays and membranes used in this experiment had the following specifications:

Tray 1: PP/EVOH/PP easy open−650 microns/min 10 microns/50 microns of PE (sealant);

Tray 2: PET A (0.31 mm)+EVOH (0.02 mm)+PE (0.02 mm)=0.35 mm;

Tray 3: PP (0.60 mm)/adhesive/PA/EVOH (0.20 mm)/PA/adhesive/PP;

Membrane A: 16.8 g metallized polyethylene terephthalate (PET)+2.0 g adhesive+27.0 g polyethylene (PE) Appeel (resin for easy open feature)=45.8 g/m2;

Membrane B: 16.8 g PET+2.0 g adhesive+15.3 g metalized BOPP+2.5 g thermo-sealing lacquer=36.6 g/m2;

Membrane C: 22 g Al+2.0 g adhesive+16.8 g PET+2.5 g thermo-sealing lacquer=49.3 g/m2; and

Membrane D: 16.8 g PET+2.0 g adhesive+21.0 g metalized PET+2.5 g thermo-sealing lacquer=39.8 g/m2.

Membrane C was used as the control membrane because aluminium foil provides a high barrier to moisture, but are generally cost prohibitive.

The pilot sealing machine was initially operated at 190° C., but all films were tearing when opening the membrane and the temperature also caused the chocolates positioned close to the sealing areas to melt. The temperature of the pilot sealing machine was then adjusted to lower temperatures which allowed the membranes to be opened and did not cause melting of the chocolate.

The results for the sealing and hermeticity experiments are provided below in Table 1. The hermeticity test was performed using a Masipack machine.

TABLE 1

| | Test 1 | Test 2 | Test 3 | Test 4 | Test 5 | Test 6 | Test 7 | Test 8 | Test 9 |
|---|---|---|---|---|---|---|---|---|---|
| Tray | Tray 3 | Tray 2 | Tray 1 | Tray 3 | Tray 2 | Tray 1 | Tray 3 | Tray 2 | Tray 1 |
| Membrane | A | A | A | B | B | B | C | C | C |
| Sealing | 120° C./ | 120° C./3 s | 120° C./3 s | 160° C./4 s | 160° C./4 s | 160° C./4 s | 120° C./3 s | 120° C./3 s | Did not |
| temperature | 3 s | | | | | | | | form seal |
| Hermeticity | 100% | 100% | 100% | 60% | 70% | 100% | 100% | 100% | n/a |
| test | | | | (failed) | (failed) | | | | |

Membrane D did not form a seal with any of the trays. Therefore, membrane A could not be used in hermeticity or shelf-life tests.

The tray and membrane combinations as described above were then tested for shelf-life over eight months in a chamber at 20° C.±2° C. and ambient humidity. The sealed trays were opened and the chocolate products were evaluated for freshness using the following scale: “1” (fresh product); “2” (similar to fresh product); “3” (some detectable sensorial difference); “4” (consumer complaints); and “5” (similar to old product). The results are presented below in Table 2.

TABLE 2

| | | Tray 3 | Tray 1 | Tray 2 |
|---|---|---|---|---|
| First Month | | | | |
| Film | A | 1 | 1 | 4 |
| | B | 2 | — | 2 |
| | C | 1 | — | 1 |
| Second Month | | | | |
| Film | A | 1 | 1 | 4 |
| | B | 2 | — | 2 |
| | C | 1 | — | 3 |
| Third Month | | | | |
| Film | A | 1 | 1 | 4 |
| | B | 2 | — | 4 |
| | C | 1 | — | 4 |
| Fourth Month | | | | |
| Film | A | 1 | 1 | NA |
| | B | 2 | — | NA |
| | C | 1 | — | NA |
| Fifth Month | | | | |
| Film | A | ~1-2 | 1 | NA |
| | B | ~2-3 | — | NA |
| | C | 1 | — | NA |
| Sixth Month | | | | |
| Film | A | 2 | 1 | NA |
| | B | ~3-4 | — | NA |
| | C | 1 | — | NA |
| Seventh Month | | | | |
| Film | A | 2 | ~1-2 | NA |
| | B | NA | — | NA |
| | C | 1 | — | NA |
| Eighth Month | | | | |
| Film | A | 3 | 2 | NA |
| | B | NA | — | NA |
| | C | 1 | — | NA |

Tray 2 gave unacceptable shelf life results during the second and third months of the test. Therefore, tray 2 was not tested after the third month. Trays 1 and 3 gave acceptable shelf-life results throughout the first six months of the test. The combination of tray 3/film B failed after the sixth month. The combinations of tray 1/membrane A and tray 3/membrane C gave the best results over the eight month experiment.

### Example 2

Various chocolate confections were tested for shelf life over 3 months. Two different types of packaging were tested. Cups comprised of PP/EVOH/PE sealed with a PETmet+PE membrane and (2) cup comprised of PP sealed with a PETmet+PE membrane were used. The samples were stored in a chamber at 20° C.±2° C. and ambient humidity.

The results presented below in Table 3, using the following key: “1” (fresh product); “2” (similar to fresh product); “3” (some detectable sensorial difference); and “4” (consumer complaints). The products tested included “SHOT”: 170 grams (milk chocolate tablet containing peanuts); “Bis laka”: 7 grams (three layers of flat wafer alternating with two layers of filling of chocolate and peanuts, with the five layered structure enrobed with white chocolate); “Sonho de valsa”: 21.5 grams (hollow wafer with fat-containing filling plus nuts, with the wafer enrobed with milk chocolate) and “Ao Leite” (milk chocolate tablets).

TABLE 3

| | |
|---|---|
| PP/EVOH/PE | PP (no EVOH) |

1st month

| | | |
|---|---|---|
| BIS LAKA | 1 | 2 |
| SONHO DE VALSA | 1 | 1 |
| SHOT | 1 | 1 |
| AO LEITE | 1 | 1 |

2nd month

| | | |
|---|---|---|
| BIS LAKA | 1 | 2 |
| SONHO DE VALSA | 1 | 2 |
| SHOT | 2 | 2 |
| AO LEITE | 1 | 1 |

3rd month

| | | |
|---|---|---|
| BIS LAKA | 1 | 2 |
| SONHO DE VALSA | 1 | 4 |
| SHOT | 2 | 3 |
| AO LEITE | 1 | 1 |

The “bis laka” samples in the cup without EVOH showed little difference in crunchiness from the “bis laka” samples in the EVOH-containing cup. The “Sonho de Valsa” samples in the cup without EVOH had cracks in the chocolate coating. The “shot” product had higher rancidity in the cup without EVOH. There was no detectable difference in the milk chocolate samples in the cups with or without EVOH.

### Example 3

Three containers were prepared and tested for oxygen transmission rate (“OTR”) and water vapor transmission rate (“WVTR”). Two of the containers included an EVOH barrier layer. The third container did not include an EVOH barrier layer. The containers were prepared as described below:

Container A: Vacuum-formed PP/EVOH/PE;

Container B: Thermoformed copolymer PP/EVOH/PE; and

Container C: Thermoformed Copolymer PP.

The containers then tested for oxygen transmission rate (“OTR”) and water vapor transmission rate (“WVTR”). As can be seen below in Table 4, the containers including an EVOH barrier layer were substantially better oxygen and water vapor barriers as compared to the container prepared without an EVOH barrier layer. For purposes herein, WVTR and OTR values less than 5 are considered “high barrier,” values between 5 and 50 are considered “medium barrier,” and values greater than 50 are considered “no barrier.” Both containers prepared with an EVOH barrier layer resulted in OTR values in the “high barrier” range. Because EVOH is generally only accepted as an oxygen barrier, it was very surprisingly found that both containers including an EVOH barrier layer also resulted in WVTR values in the “high barrier” range.

TABLE 4

| Container A: | | Container B: | | Container C: | |
|---|---|---|---|---|---|
| PP/EVOH/PE | | Copolymer PP/EVOH/PE | | Copolymer PP | |
| Thickness of | 600 microns | Thickness of | 1500 microns | Thickness of | 1500 microns |
| sheet | | sheet | | sheet | |
| WVTR | 0.353 g/m²/24 hr | WVTR | 0.358 g/m²/24 hr | WVTR | >500 g/m²/24 hr |
| OTR | 0.799 cc/m²/24 hr | OTR | 1.650 cc/m²/24 hr | OTR | >500 cc/m²/24 hr |
| Thickness of | 300 microns | Thickness of | 300 microns | Thickness of | 300 microns |
| container | | Cup | | Cup | |
| WVTR | 0.455 g/m²/24 hr | WVTR | 0.650 g/m²/24 hr | WVTR | >500* g/m²/24 hr |
| OTR | 1.027 cc/m²/24 hr | OTR | 3.010 cc/m²/24 hr | OTR | >500* cc/m²/24 hr |

While the invention has been particularly described with specific reference to specific embodiments, it will be appreciated that various alterations, modifications, and adaptations may be based on the present disclosure, and are intended to be within the spirit and scope of the present invention as defined by the following claims.

What is claimed is:

1. A packaged chocolate confectionery product comprising:
a plurality of chocolate confectionery items comprising a first chocolate component and a second component comprising a food ingredient selected from the group consisting of nuts, wafers, biscuits, liqueurs, fruit fillings, fat-containing fillings, and combinations thereof;
a rigid thermoformed container comprising at least one recessed area surrounded by a peripheral sealing rim, the container being formed of a thermoplastic laminate comprising at least one oxygen barrier layer positioned between at least one inner layer and at least one outer polymer layer, the barrier layer being substantially impervious to oxygen and effective to enhance the moisture barrier properties of the container; and
a membrane sealed to the peripheral sealing rim, the membrane comprising a metalized film that is substantially impervious to oxygen and water vapor,
wherein the sealed container has an oxygen transmission rate of less than 5 cc/m²/24 hr and a water vapor transmission rate of less than 5 g/m²/24 hr.

2. The package according to claim 1 wherein the barrier layer comprises EVOH.

3. The package according to claim 1 wherein the inner polymer layer and outer polymer layers comprise at least one polymer selected from the group consisting of polypropylene, polyethylene, polyamide, and combinations thereof.

4. The package according to claim 1 wherein the at least one inner and outer layers comprises about 70 to about 97 percent of the thickness of the container.

5. The package according to claim 1 wherein the barrier layer comprises about 1 to about 20 of the thickness of the container.

6. The package according to claim 1 wherein the container has an oxygen transmission rate of less than 3 cc/m²/24 hr and a water vapor transmission rate of less than 3 g/m²/24 hr.

7. The package according to claim 1 wherein the container has an oxygen transmission rate of less than 1 cc/m²/24 hr and a water vapor transmission rate of less than 1 g/m²/24 hr.

8. A method for improving the shelf-life of chocolate confections, the method comprising:
(1) a rigid thermoformed or injection formed container comprising at least one recessed area surrounded by a peripheral sealing rim, the container being formed of a thermoplastic laminate comprising at least one oxygen barrier layer positioned between at least one inner layer and at least one outer polymer layer, the barrier layer being substantially impervious to oxygen and effective to enhance the moisture barrier properties of the container;
(2) depositing one or more chocolate confectionery items in the at least one recessed area of the container, the one or more chocolate confectionery items comprising a first chocolate component and a second component comprising a food ingredient selected from the group consisting of nuts, wafers, biscuits, liqueurs, fruit fillings, fat-containing fillings, and combinations thereof; and
(3) sealing a membrane to the peripheral sealing rim, the membrane comprising a metalized film that is substantially impervious to oxygen and water vapor,
wherein the sealed container has an oxygen transmission rate of less than 5 cc/m²/24 hr and a water vapor transmission rate of less than 5 g/m²/24 hr.

9. The method according to claim 8 wherein the one or more chocolate confectionery items is selected from the group consisting of solid chocolate, nut-containing chocolates, enrobed chocolates, truffles, solid molded chocolates, filled molded chocolates, and hollow molded chocolates.

10. The method according to claim 8 wherein the barrier layer comprises EVOH.

11. The method according to claim 8 wherein the inner polymer layer and outer polymer layers comprise at least one polymer selected from the group consisting of polypropylene, polyethylene, polyamide, and combinations thereof.

12. The method according to claim 8 wherein the at least one inner and outer layers comprises about 70 to about 97 percent of the thickness of the container.

13. The method according to claim 8 wherein the barrier layer comprises about 1 to about 20 of the thickness of the container.

14. The method according to claim 8 wherein the sealed container has an oxygen transmission rate of less than 3 cc/m²/24 hr and a water vapor transmission rate of less than 3 g/m²/24 hr.

15. The method according to claim 8 wherein the sealed container has an oxygen transmission rate of less than 1 cc/m²/24 hr and a water vapor transmission rate of less than 1 g/m²/24 hr.

16. The method according to claim 8 wherein the chocolate confections are sealed in the container after flushing the container with nitrogen.

17. A method of making a packaged chocolate confectionery product having a shelf life, comprising:
making at least one chocolate confectionery item comprising a chocolate component and a non-chocolate component;
providing a sheet of material suitable for thermoforming or injection forming a rigid container, said sheet comprising at least one barrier layer having an average thickness between at least one inner layer and at least one outer layer;
forming a rigid thermoformed or injection formed container comprising an upper wall and at least one cavity having a mouth, said upper wall of said container comprising a peripheral sealing rim surrounding said mouth;
said at least one cavity comprising at least one sidewall having an average wall thickness, and at least one bottom wall;
filling said at least one cavity with said at least one chocolate confectionery item in a gas-flushed environment; and
sealing a membrane to said peripheral sealing rim;
wherein said container and said membrane each have an oxygen transmission rate of less than 5 cc/m²/24 hr and a water vapor transmission rate of less than 5 g/m²/24 hr; and wherein the variation between the average thickness of said barrier layer may be described by the following inequality:
$${x}_{1} \leq \frac{a}{b} \leq {x}_{2}$$
where
a=said average thickness of said barrier layer in said cavity sidewall;
b=said average thickness of said barrier layer in said sheet;
x₁=0.25; and
x₂=0.75.

18. The method of claim 17 wherein a is between about 1 micron and about 20 microns.

19. The method of claim 18 wherein said barrier material comprises EVOH.

20. The method of claim 19 wherein said membrane comprises a metal foil barrier layer.
